(19) United States
(12) Patent Application Publication
(10) Pub. No.: US 2024/0121373 A1
(43) Pub. Date: Apr. 11, 2024

(54) IMAGE DISPLAY METHOD AND 3D DISPLAY SYSTEM

(71) Applicant: Acer Incorporated, New Taipei City (TW)

(72) Inventors: Kai-Hsiang Lin, New Taipei City (TW); Hung-Chun Chou, New Taipei City (TW); Wen-Cheng Hsu, New Taipei City (TW); Shih-Hao Lin, New Taipei City (TW); Chih-Haw Tan, New Taipei City (TW)

(73) Assignee: Acer Incorporated, New Taipei City (TW)

(21) Appl. No.: 18/314,826

(22) Filed: May 10, 2023

(30) Foreign Application Priority Data
Oct. 7, 2022 (TW) 111138202

(51) Int. Cl. H04N 13/302; G06T 7/10; G06T 15/00; G06V 10/74

(52) U.S. Cl. CPC H04N 13/302; G06T 7/10; G06T 15/00; G06V 10/761; G06T 2207/20228

(57) ABSTRACT

Disclosed are an image display method and a 3d display system. The method is adapted to the 3d display system including a 3d display device and includes the following steps. A first image and a second image are obtained by splitting an input image according to a 3d image format. Whether the input image is a 3D format image complying with the 3D image format is determined through a stereo matching processing performed on the first image and the second image. An image interweaving process is enabled to be performed on the input image to generate an interweaving image in response to determining that the input image is the 3D format image complying with the 3D image format, and the interweaving image is displayed via the 3D display device.

### CROSS-REFERENCE TO RELATED APPLICATION

This application claims the priority benefit of Taiwan application serial no. 111138202, filed on Oct. 7, 2022. The entirety of the above-mentioned patent application is hereby incorporated by reference herein and made a part of this specification.

### BACKGROUND

### Technical Field

The disclosure relates to a display system, and in particular to an image display method and a 3D display system.

### Description of Related Art

With the advancement of display technology, displays supporting three-dimension (3D) image playback have gradually become popular. The difference between 3D display and two-dimensional (2D) display is that 3D display technology allows the viewer to feel the three-dimensionality in the image, such as the three-dimensional facial features of the characters and the depth of field, etc., while the traditional 2D images cannot show this effect. The principle of 3D display technology is to let the viewer's left eye watch the left-eye image and let the viewer's right eye watch the right-eye image, so that the viewer can feel the 3D visual effect. With the vigorous development of 3D stereoscopic display technology, it can provide people with a visually immersive experience. It is known that the 3D display needs to use the corresponding 3D display techniques to play the images in a specific 3D image format. Otherwise, the 3D display will not be able to display images correctly. Therefore, how to accurately identify the image content complying with a specific 3D image format is a topic of concern to those skilled in the art.

### SUMMARY

In view of this, the disclosure proposes an image display method and a 3D display system, which may accurately identify whether an input image is a 3D format image.

The embodiment of the disclosure provides an image display method, which is adapted to a 3D display system comprising a 3D display device, and comprises the following steps. A first image and a second image are obtained by splitting the input image according to the 3D image format. By performing a stereo matching process on the first image and the second image, it is determined whether the input image is a 3D format image complying with the 3D image format. In response to determining that the input image is a 3D format image complying with the 3D image format, an image interweaving process is enabled to be performed on the input image to generate an interweaving image, and displays the interweaving image through the 3D display device.

The embodiment of the disclosure provides a 3D display system, which comprises a 3D display device, a storage device, and a processor. The processor is connected to the storage device and the 3D display device and is configured to execute the following steps. A first image and a second image are obtained by splitting the input image according to the 3D image format. By performing a stereo matching process on the first image and the second image, it is determined whether the input image is a 3D format image complying with the 3D image format. In response to determining that the input image is a 3D format image complying with the 3D image format, an image interweaving process is enabled to be performed on the input image to generate an interweaving image, and displays the interweaving image through the 3D display device.

The embodiment of the disclosure provides an image display method, which is adapted to a 3D display system comprising a 3D display device, and comprises the following steps. A first image and a second image are obtained by splitting the input image according to the 3D image format. By performing a stereo matching process on the first image and the second image, it is determined whether the input image is a 3D format image complying with the 3D image format. In response to determining that the input image is a 3D format image complying with the 3D image format, the 3D display device is switched to operate in a 3D stereoscopic display mode according to the 3D image format.

The embodiment of the disclosure provides a 3D display system, which comprises a 3D display device, a storage device, and a processor. The processor is connected to the storage device and the 3D display device, and is configured to execute the following steps. A first image and a second image are obtained by splitting the input image according to the 3D image format. By performing a stereo matching process on the first image and the second image, it is determined whether the input image is a 3D format image complying with the 3D image format. In response to determining that the input image is a 3D format image complying with the 3D image format, the 3D display device is switched to operate in a 3D stereoscopic display mode according to the 3D image format.

Based on the above, in the embodiment of the disclosure, the input image is split to obtain the first image and the second image based on the 3D image format. By performing the stereo matching process on the first image and the second image, it may be determined whether the input image complies with the 3D image format, so as to automatically switch the display mode of the 3D display device or enable the image interweaving process according to the result of the determination. In this way, not only may it be effectively determined whether the input image is a 3D format image, but also the user experience and application range of the 3D display technology can be improved.

### BRIEF DESCRIPTION OF THE DRAWINGS

FIG. 1 is a schematic figure of an electronic device according to an embodiment of the disclosure.

FIG. 2 is a flowchart of detecting 3D format images according to an embodiment of the disclosure.

FIGS. 3A-3D are schematic figures of splitting an input image according to an embodiment of the disclosure.

FIG. 4 is a flowchart of determining whether an input image is a 3D format image according to an embodiment of the disclosure.

FIG. 5 is a flowchart of detecting 3D format images according to an embodiment of the disclosure.

FIG. 6 is a schematic figure of obtaining a disparity map according to an embodiment of the disclosure.

FIG. 7 is a schematic figure of a naked-eye 3D display device of an image display method according to an embodiment of the disclosure.

FIG. 8 is a flowchart of an image display method according to an embodiment of the disclosure.

FIG. 9 is a flowchart of an image display method according to an embodiment of the disclosure.

FIG. 10 is a flowchart of an image display method according to an embodiment of the disclosure.

FIG. 11 is a flowchart of an image display method according to an embodiment of the disclosure.

### DESCRIPTION OF THE EMBODIMENTS

Parts of the embodiments of the disclosure will be described in detail with reference to the accompanying drawings. For the referenced symbols in the following description, when the same reference symbols appear in different drawings, they will be regarded as the same or similar components. These embodiments are only a part of the disclosure, and do not disclose all possible implementation modes of the disclosure. More specifically, these embodiments are merely examples of devices and methods within the scope of the disclosure.

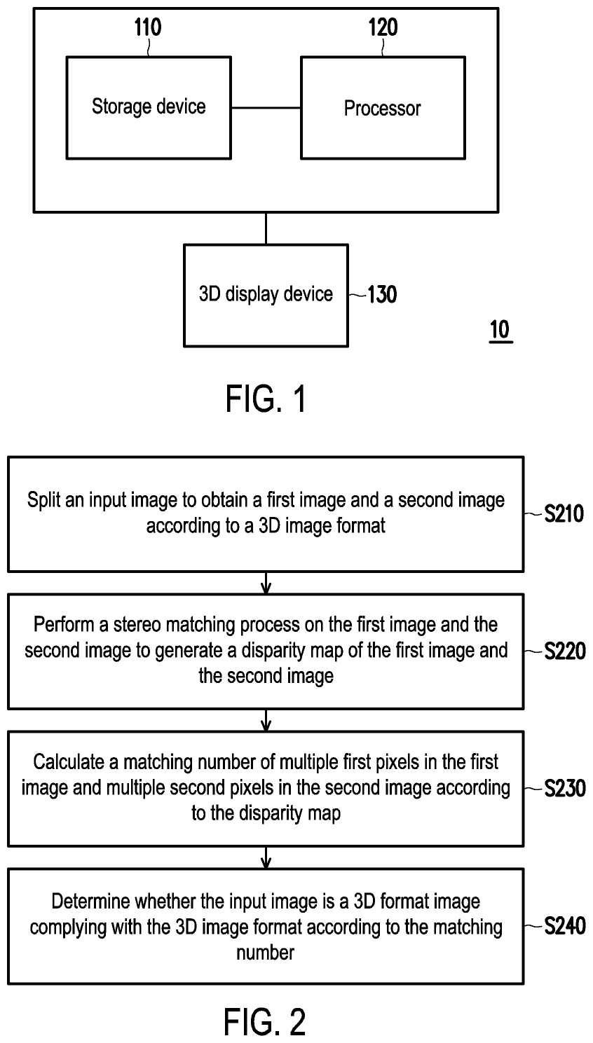

FIG. 1 is a schematic figure of an electronic device according to an embodiment of the disclosure. Referring to FIG. 1, the 3D display system 10 may comprise a 3D display device 130, a storage device 110 and a processor 120. The processor 120 is coupled to the storage device 110 and the 3D display device 130. The 3D display system 10 may be a single integrated system or a separate system. Specifically, the 3D display device 130, the storage device 110, and the processor 120 of the 3D display system 10 may be implemented as an all-in-one (AIO) electronic device, such as a game console, a smart phone, a notebook computer or a tablet and more. Alternatively, the 3D display system 10 may be implemented by multiple electronic products, and the 3D display device 130 may be connected to the processor 120 of the computer system through a wired transmission interface or a wireless transmission interface.

The 3D display device 130 may let the user experience a 3D visual effect. The 3D display device 130 may allow the user's left eye and right eye to see image content corresponding to different viewing angles (i.e., left-eye image and right-eye image) according to its hardware specifications and the applied 3D display techniques. In some embodiments, the 3D display device 130 may be a naked-eye 3D display or a glasses-type 3D display, such as a display of a notebook computer, a TV, a desktop screen or an electronic signage, and the like. Alternatively, in some other embodiments, the 3D display device 130 may be implemented as a head-mounted display device, such as an AR display device, a VR display device, or an MR display device, and so on.

The storage device 110 is configured to store images, data, and program codes accessed by the processor 120 (such as operating systems, applications, and drivers). It may be, for example, any type of fixed or removable random access memory (RAM), read-only memory (ROM), flash memory, hard disk or a combination thereof.

The processor 120 is coupled to the storage device 110 and is, for example, a central processing unit (CPU), an application processor (AP), or other programmable general purpose or special purpose microprocessor, digital signal processor (DSP), image signal processor (ISP), graphics processing unit (GPU) or other similar devices, integrated circuits or combinations thereof. The processor 120 may access and execute the program codes and software modules recorded in the storage device 110 to implement the image display method in the embodiment of the disclosure. The above-mentioned software modules may be broadly interpreted to denote instructions, instruction sets, codes, programming codes, programs, applications, software suites, threads, processes, functions, and the like, be it referred to as software, firmware, intermediate software, microcode, hardware description languages, or the like.

Generally speaking, in order to allow users to experience 3D visual effects, two images from different viewing angles (i.e., the left-eye image and the right-eye image) may be synthesized into a 3D format image. Through different 3D display techniques, the 3D format image is displayed, allowing the viewer's left eye to see the left-eye image and allowing the viewer's right eye to see the right-eye image. That is, the 3D format image comprises image content corresponding to the first viewing angle and the second viewing angle. In the embodiment of the disclosure, the 3D display system 10 may determine whether the input image is a 3D format image complying with a certain 3D image format. In other words, the 3D format image may be a synthetic image of the left-eye image and the right-eye image. In this way, in some embodiments, the 3D display device 130 may support various display modes, such as a 2D display mode and a 3D stereoscopic display mode associated with one or more 3D display techniques. If the 3D display system 10 may accurately determine what type of the 3D format image that the input image is, the 3D display device 130 may automatically switch to a suitable display mode to display the 3D image content.

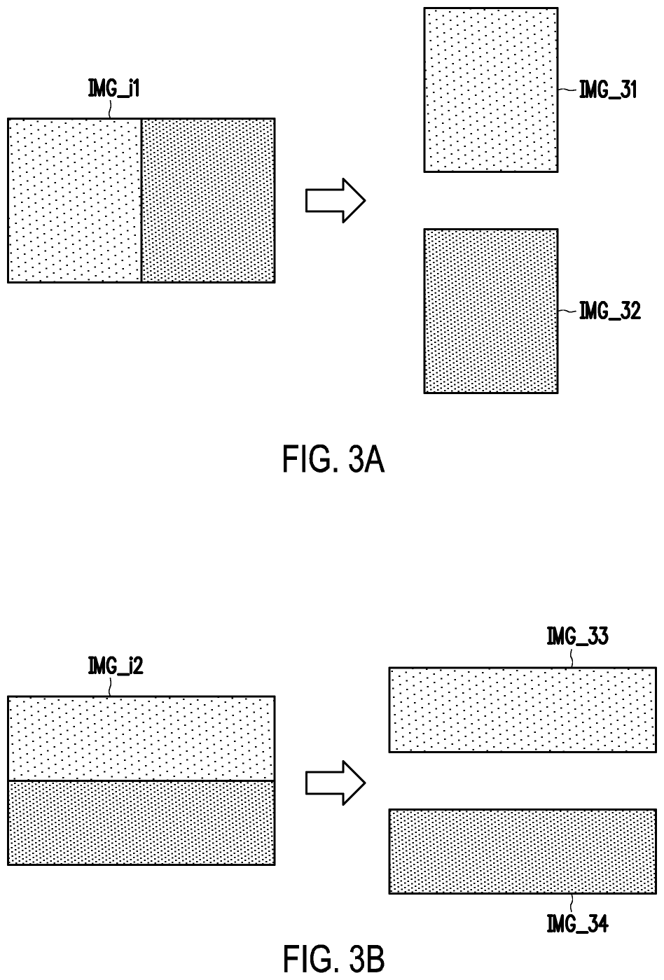

FIG. 2 is a flowchart of detecting 3D format images according to an embodiment of the disclosure. Please refer to FIG. 2, the method of this embodiment is applicable to the 3D display system 10 in the above-mentioned embodiment, and the detailed steps of this embodiment will be described below with various components in the 3D display system 10.

In step S210, the processor 120 splits the input image to obtain a first image and a second image according to the 3D image format. In some embodiments, the input image may be an image stream or a single frame image in a video. In some embodiments, the input image may be an image obtained by using a screen capture function. In some embodiments, the input image may be, for example, an image generated by an application. In some embodiments, the first image size is the same as the second image size. In other words, the 3D format image may be split into two images with the same resolution.

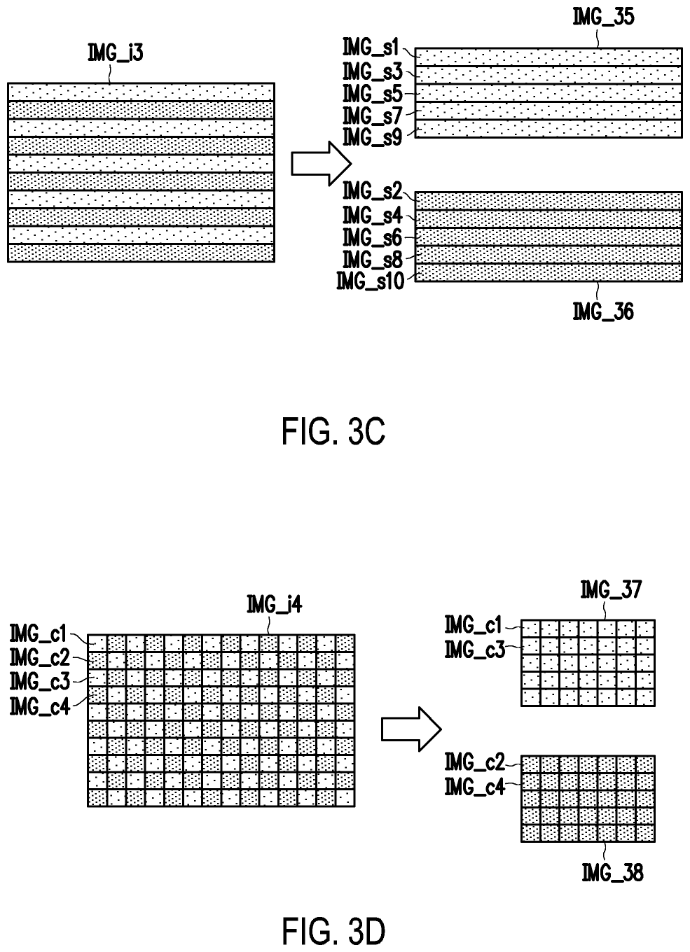

In some embodiments, the 3D image format may comprise a side-by-side format, a top-to-bottom format, a checkerboard pattern format, or an interlacing format. The processor 120 extracts the first image and the second image from the 3D format image according to the type of the 3D image format. For example, FIGS. 3A-3D are schematic figures of splitting an input image according to an embodiment of the disclosure.

Please refer to the embodiment shown in FIG. 3A, when it is necessary to detect whether the input image IMG_i1 complies with the side-by-side (SBS) format, the processor 120 may split the input image IMG_i1 into the first image IMG_31 on the left half and the second image IMG_32 on the right half.

Please refer to the embodiment shown in FIG. 3B, when it is necessary to detect whether the input image IMG_i2 complies with the top-and-bottom (TB) format, the processor 120 may split the input image IMG_i2 into the first image IMG_33 on the upper half and the second image IMG_34 on the lower half.

Please refer to the embodiment shown in FIG. 3C, when it is necessary to detect whether the input image IMG_i3 complies with the interlacing format, the processor 120 may first split the input image IMG_i3 into multiple sub-images IMG_s1-IMG_s10 along the horizontal direction. Then, the processor 120 combines the sub-images IMG_s1, IMG_s3, IMG_s5, IMG_s7, and IMG_s9 to obtain a first image IMG_35, and combines the sub-images IMG_s2, IMG_s4, IMG_s6, IMG_s8, and IMG_s10 to obtain a second image IMG_36. However, the number of sub-images shown in FIG. 3C is only for exemplary illustration, and is not intended to limit the disclosure.

Please refer to the embodiment shown in FIG. 3D, when it is necessary to detect whether the input image IMG_i4 complies with the checkerboard format, the processor 120 may first split the input image IMG_i4 into multiple sub-images in an arrangement of a checkerboard according to the checkerboard pattern (for example sub-images IMG_c1, IMG_c2, IMG_c3, IMG_c4). Then, the processor 120 combines multiple sub-images (such as sub-images IMG_c1 and IMG_c3) to obtain a first image IMG_37, and combines multiple sub-images (such as sub-images IMG_c2 and IMG_c4) to obtain a second image IMG_38. However, the number of sub-images shown in FIG. 3D is only for exemplary illustration, and is not intended to limit the disclosure.

Next, in step S220, the processor 120 performs a stereo matching process on the first image and the second image to generate a disparity map of the first image and the second image. In some embodiments, according to a block-matching algorithm, the processor 120 may perform the stereo matching process on the first image and the second image to estimate disparity information and may obtain a disparity map. In some embodiments, according to an optical flow algorithm, the processor 120 may perform the stereo matching process on the first image and the second image, so as to estimate disparity information and may obtain a disparity map. In some embodiments, the processor 120 may input the first image and the second image into a trained deep neural network model to obtain a disparity map. In some embodiments, the number of elements in the disparity map is equal to the resolutions of the first image and the second image. For example, assuming that the resolutions of the first image and the second image are 640*480, the disparity map may comprise disparity information corresponding to 640*480 pixel positions.

In step S230, the processor 120 calculates the matching number of multiple first pixels in the first image and multiple second pixels in the second image according to the disparity map. In some embodiments, the disparity map comprises multiple valid disparity values and multiple invalid disparity values, and the matching number is the number of valid disparity values.

In detail, during the stereo matching process, if a certain first pixel in the first image may be successfully matched to a certain second pixel in the second image, the processor 120 may obtain the corresponding valid disparity value. On the contrary, if a certain first pixel in the first image may not be successfully matched to any second pixel in the second image, the processor 120 may obtain the corresponding invalid disparity value. Therefore, by counting the number of valid disparity values in the disparity map, the matching number of the multiple first pixels in the first image successfully matched to the multiple second pixels in the second image may be obtained. In some embodiments, the invalid disparity value in the disparity map is set to a negative value, and the valid disparity value in the disparity map is set to an integer value greater than or equal to 0, but the disclosure is not limited thereto.

In step S240, the processor 120 determines whether the input image is a 3D format image complying with the 3D image format according to the matching number. It may be known that if the matching number is large enough, it may be determined that the first image and the second image are left-eye image and right-eye image corresponding to the same shooting scene, so the processor 120 may determine that the input image is a 3D format image complying to the 3D image format.

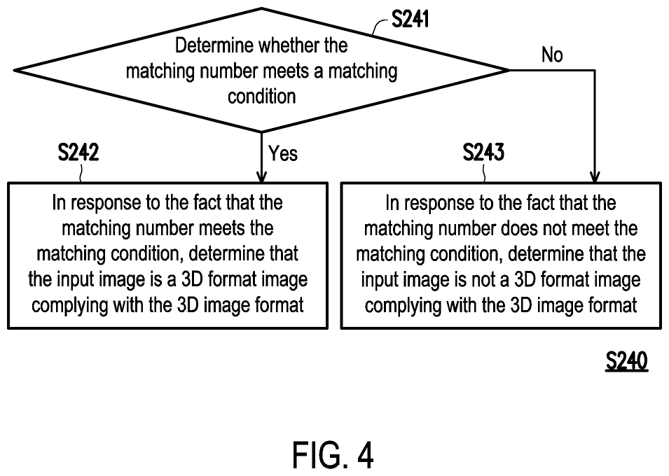

In more detail, FIG. 4 is a flowchart of determining whether an input image is a 3D format image according to an embodiment of the disclosure. Please refer to FIG. 4, step S240 may be implemented as sub-steps S241 to S243. In sub-step S241, the processor 120 determines whether the matching number meets a matching condition.

In some embodiments, the processor 120 compare the matching number with a preset threshold value to determine whether the matching number meets the matching condition. If the matching number is greater than the preset threshold value, the processor 120 may determine that the matching number meets the matching condition. If the matching number is not greater than the preset threshold value, the processor 120 may determine that the matching number does not meet the matching condition. The above preset threshold value may be set according to the image resolution of the input image. That is, different image resolutions may correspond to different preset threshold values.

In some embodiments, the processor 120 may calculate a matching ratio between the matching number and the pixel number of the first image, and determines whether the matching ratio is greater than a threshold value. That is, the matching ratio is a ratio of the successfully matched first pixels to all the first pixels in the first image, which may be represented by a percentage or a value which is less than 1 and greater than 0. If the matching ratio is greater than the threshold value, the processor 120 determines that the matching number meets the matching condition. If the matching ratio is not greater than the threshold value, the processor 120 determines that the matching number does not meet the matching condition. In the embodiment of comparing the matching ratio and the threshold value, the same threshold value may be applied to different image resolutions.

If the determination in step S241 is ‘yes’, in sub-step S242, in response to the fact that the matching number meets the matching condition, the processor 120 determines that the input image is a 3D format image complying with the 3D image format. On the contrary, if the determination in step S241 is ‘no’, in sub-step S243, in response to the fact that the matching number does not meet the matching condition, the processor 120 determines that the input image is not a 3D format image complying with the 3D image format. That is, if the matching number meets the matching condition, it means that the first image and the second image extracted from the input image are the left-eye image and the right-eye image corresponding to the same scene, and thus it may be determined that the input image is a 3D format image. Based on this, a disparity map is obtained by performing the stereo matching process on the first image and the second image. Whether the input image complies with the 3D image format may be determined based on the matching situation presented by the disparity map.

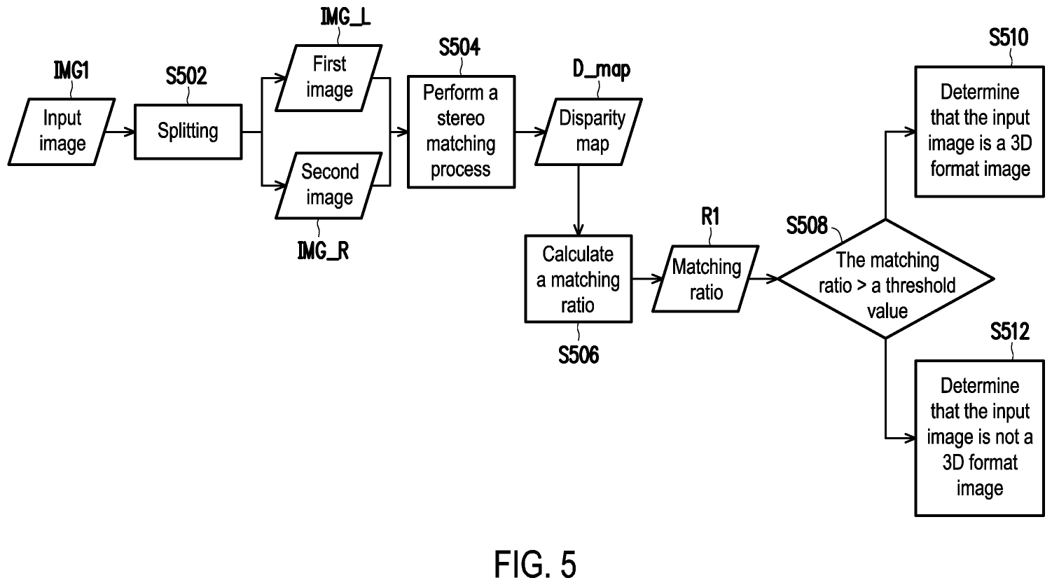

FIG. 5 is a flowchart of detecting 3D format images according to an embodiment of the disclosure Please refer to FIG. 5, the method of this embodiment is applicable to the 3D display system 10 in the above-mentioned embodiment, and the detailed steps of this embodiment will be described below with various components in the 3D display system 10.

In step S502, the processor 120 splits the input image IMG1 to obtain the first image IMG_L and the second image IMG_R according to the 3D image format. In step S504, the processor 120 performs the stereo matching process on the first image IMG_L and the second image IMG_R to generate a disparity map D_map of the first image IMG_L and the second image IMG_R.

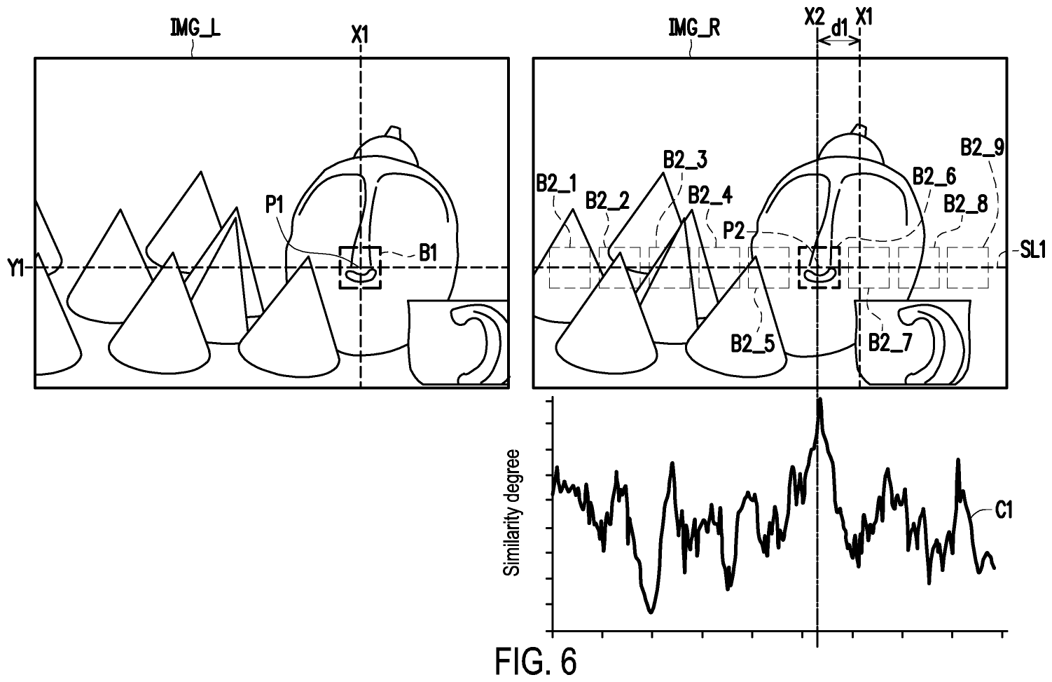

In detail, FIG. 6 is a schematic figure of obtaining a disparity map according to an embodiment of the disclosure. The processor 120 takes the first image block B1 with the first target pixel point P1 of the first image IMG_L as the center. Next, the processor 120 may obtain a horizontal scanning line SL1 according to the Y-axis position of the first target pixel point P1, so as to obtain multiple second image blocks on the second image IMG_R along the horizontal scanning line SL1 (FIG. 6 is described with the image blocks B2_1 to B2_9 as representatives). That is, the Y-axis position of the first image block B1 is the same as the Y-axis positions of the second image blocks B2_1-B2_9, and the size of the first image block B1 is the same as the size of the second image blocks B2_1-B2_9. It should be noted that the nine second image blocks B2_1-B2_9 in FIG. 6 are only for exemplary illustration. In some embodiments, the processor 120 may obtain multiple second image blocks with one pixel as a scanning unit.

Then, the processor 120 calculates multiple similarity degrees between the first image block B1 and the multiple second image blocks on the second image IMG_R. In some embodiments, these similarity degrees may also be matching costs or values generated based on the matching costs. For example, the processor 120 may sequentially calculate the absolute difference value between the grayscale value of each first pixel point on the first image block B1 and the grayscale value of the corresponding second pixel point on the second image block B2_1 value, and may take the reciprocal after adding all the absolute difference values to obtain the similarity degree between the first image block B1 and the second image block B2_1. Assuming that the size of the first image block B1 is 91*91, the processor 120 may obtain 91*91 absolute difference values.

However, in other embodiments, the processor 120 may also obtain the matching costs corresponding to multiple second image blocks based on other calculation methods, such as Square Difference (SD) algorithm, Pixel Dissimilarity Measure (PDM) algorithm, Normalized Cross Correlation (NCC) algorithm, etc. In some embodiments, the processor 120 may also perform cost aggregation to obtain the matching costs corresponding to multiple second image blocks. By repeatedly performing the steps of the similarity degree calculation along the horizontal scanning line SL1, the processor 120 may obtain similarity degrees corresponding to multiple second image blocks respectively. That is, the processor 120 sequentially performs the similarity degree calculation between the first image and each second image block to obtain similarity degrees respectively corresponding to the multiple second image blocks. Therefore, the processor 120 may obtain a valid disparity value or an invalid disparity value corresponding to the first target pixel point P1 on the disparity map D_map according to the similarity degrees respectively corresponding to the multiple second image blocks on the horizontal scanning line SL1.

In detail, according to the similarity degrees corresponding to the multiple second image blocks on the horizontal scanning line SL1, the processor 120 may determine whether the first image block B1 matches one of the multiple second image blocks. In the example of FIG. 6, the similarity degrees corresponding to the multiple second image blocks on the horizontal scanning line SL1 may be shown as the similarity degree curve C 1. The processor 120 may search for a second target image block (i.e., the second image block B2_6 shown in FIG. 6) matching the first target image block B1 according to the similarity degree curve Cl. For example, if the processor 120 may search for the maximum similarity degree of the similarity curve Cl and the maximum similarity is greater than a similarity threshold value, the processor 120 may determine that the first image block B1 matches the second image block B2_6 corresponding to the maximum similarity degree. Alternatively, in some embodiments, if the processor 120 may also search for the minimum difference degree among the multiple difference degrees and the minimum difference degree is smaller than a difference degree threshold value, the processor 120 may determine that the first image block B1 matches a second image block corresponding to the aforementioned minimum difference degree. In some embodiments, the difference degree and the similarity degree may have a reciprocal relationship. In addition, in some embodiments, the processor 120 may also substitute these matching costs into an energy function, and optimizes the energy function to search for the second image block matching the first image block B1.

As shown in FIG. 6, if the second target image block matching the first target image block B1 (i.e., the second image block B2_6) among the second image blocks is obtained according to the similarity degree, the processor 120 may obtain an valid disparity value dl corresponding to the first target pixel point P1 on the disparity map D_map based on the X-axis position X2 of the second target pixel point P2 centered on the second target image block and the X-axis position X1 of the first target pixel point P1. On the other hand, if the second target image block matching the first target image block B1 among the second image blocks is not obtained according to the similarity degree, it means that the similarity degrees corresponding to these second image blocks does not meet the preset conditions, such as the maximum similarity degree is not greater than the similarity degree threshold value, the minimum difference degree is not less than the difference degree threshold value, or the problem of optimizing the energy function has no solution, etc. Therefore, if the second target image block matching the first target image block B1 in the second image block is not obtained according to the similarity degree, the processor 120 may obtain an invalid disparity value corresponding to the first target pixel point P1 on the disparity map D_map. Alternatively, in some embodiments, the processor 120 may perform a denoising process on the disparity map D_map, and replaces multiple original valid disparity values whose degree of confidence is low with invalid disparity values.

Please return to FIG. 5, in step S506, the processor 120 calculates the matching number according to the disparity map D_map, and calculates a matching ratio R1 between the matching number and the pixel number of the first image IMG_L. That is, the matching ratio R1 is obtained by dividing the matching number by the pixel number of the first image IMG_L. In step S508, the processor 120 determines whether the matching ratio R1 is greater than a threshold value. If the situation is ‘yes’, in step S510, the processor 120 determines that the input image is a 3D format image, and controls the 3D display 20 to display the input image in a corresponding 3D stereoscopic display mode. For example, the processor 120 may determine that the input image complies with the side-by-side image format, and obtains two images with different viewing angles accordingly. If the situation is ‘no’, in step S510, the processor 120 determines that the input image is not a 3D format image, and may control the 3D display 20 to display the input image in a 2D display mode.

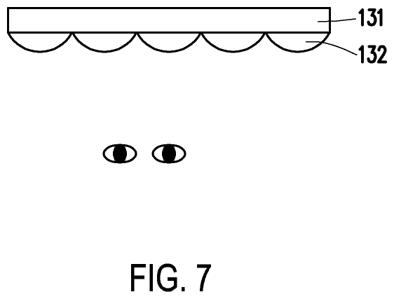

FIG. 7 is a schematic figure of a naked-eye 3D display device of an image display method according to an embodiment of the disclosure. In one embodiment, the 3D display device 130 shown in FIG. 1 may be implemented as a naked-eye 3D display device, which may provide different images with aberrations to the left eye and the right eye through the lens refraction principle, so that the viewer experiences the 3D display effect.

The 3D display device 130 may comprise a display panel 131 and a lens element layer 132. The lens element layer 132 is disposed above the display panel 131 and may comprise a straight cylindrical convex lens film. The user sees the image content provided by the display panel 131 through the lens element layer 132. The lens element layer 132 refracts different display content to different places in space by refracting light, so that human eyes receive two images with parallax. The structure and implementation of the 3D display device 130 are not the focus of the disclosure, and will not be described in detail here. The disclosure does not limit the type and structure of the display panel 131, and the display panel 131 may also be a self-luminous display panel. In some other embodiments, the lens element layer 132 may be realized by a liquid crystal lens or replaced by a grating.

It should be noted that when the light passes through the convex lens, the direction of travel is refracted and changed, so the left-eye image and the right-eye image must be staggered vertically, and then the light passes through a series of closely arranged cylindrical convex lenses in the cylindrical convex lens film, so that the left and right eyes may see their respective images. More specifically, the left-eye image may be presented through multiple left-eye pixels corresponding to the left eye on the display panel 131, and the right-eye image may be presented through multiple right-eye pixels corresponding to the right eye on the display panel 131. Correspondingly, the processor 120 needs to perform the image interweaving process on the 3D format image to interlace the left-eye image and right-eye image with parallax to form an interweaving image, so that the multiple left-eye pixels corresponding to the left eye on the display panel 131 display the left-eye image, and the multiple right-eye pixels corresponding to the right eye on the display panel 131 display the right-eye image.

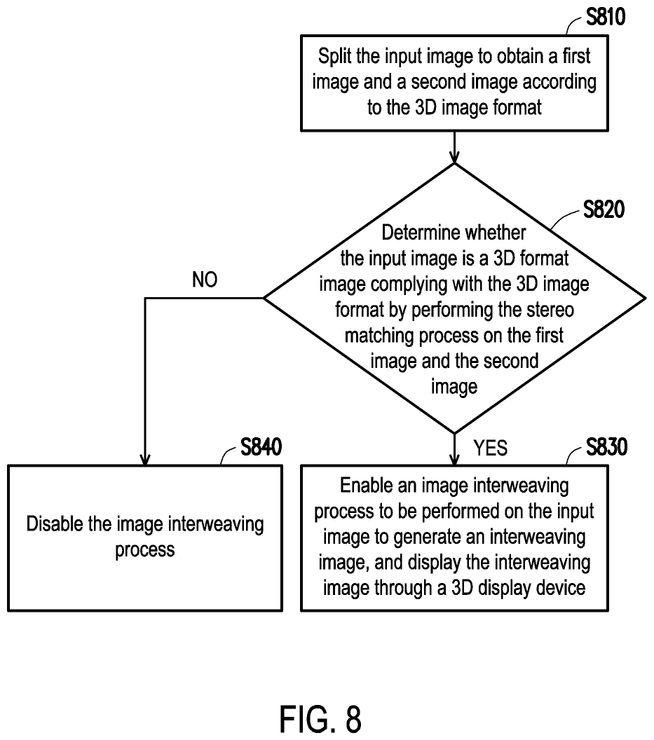

FIG. 8 is a flowchart of an image display method according to an embodiment of the disclosure. The method shown in FIG. 8 is applicable to the 3D display system 10 shown in FIG. 1. In step S810, according to the 3D image format, the processor 120 splits the input image to obtain a first image and a second image. In step S820, the processor 120 determines whether the input image is a 3D format image complying with the 3D image format by performing the stereo matching process on the first image and the second image. The detailed implementations of step S810 to step S820 have been clearly described in the relevant descriptions of FIG. 2 to FIG. 6, and will not be repeated here.

In step S830, in response to determining that the input image is a 3D format image complying with the 3D image format (if the determination of step S820 is ‘yes’), the processor 120 enables an image interweaving process to be performed on the input image to generate an interweaving image, and displays the interweaving image through the 3D display device 130. For example, when the processor 120 determines that the input image is a 3D format image complying with the side-by-side image format, the processor 120 may extract a left-eye image and a right-eye image from the input image, and interweaves the left-eye image and the right-eye image. In more detail, the processor 120 splits the left-eye image into multiple left-eye image strips along a splitting direction, and splits the right-eye image into multiple right-eye image strips along the splitting direction. Next, the processor 120 interweaves the left-eye image strips and the right-eye image strips to synthesize an interweaving image. In this way, in response to the fact that the processor 120 determine that the image to be displayed comprises a 3D format image complying with the 3D image format, the processor 120 may enable the image interweaving process to be performed on the 3D format image. When the naked-eye 3D display operating in the 3D stereoscopic format display mode displays the interweaving image, the user may feel the 3D visual effect that the display object floats out of the screen.

On the other hand, in step S840, in response to determining that the input image is not a 3D format image complying with the 3D image format (the determination of step S820 is ‘no’), the processor 120 disables an image interweaving process. In some embodiments, when the processor 120 determines that the input image is not a 3D format image complying with the 3D image format, the processor 120 may directly provide the input image to the 3D display device 130 for display.

On the other hand, in some embodiments, according to whether the input image is a 3D format image complying with the 3D image format, the processor 120 may decide whether to deliver the input image to a runtime complying with a specific development standard and to enable the image interweaving process. The runtime is developed according to specific development standards and hardware characteristics of the 3D display device 130. A specific development standard is, for example, the OpenXR standard. When the input image is a 3D format image complying with the 3D image format, the processor 120 may determine to deliver the input image to the runtime complying with a specific development standard to enable the image interweaving process. On the contrary, when the input image is not a 3D format image complying with the 3D image format, the processor 120 may determine not to deliver the input image to the runtime complying with a specific development standard to disable the image interweaving process.

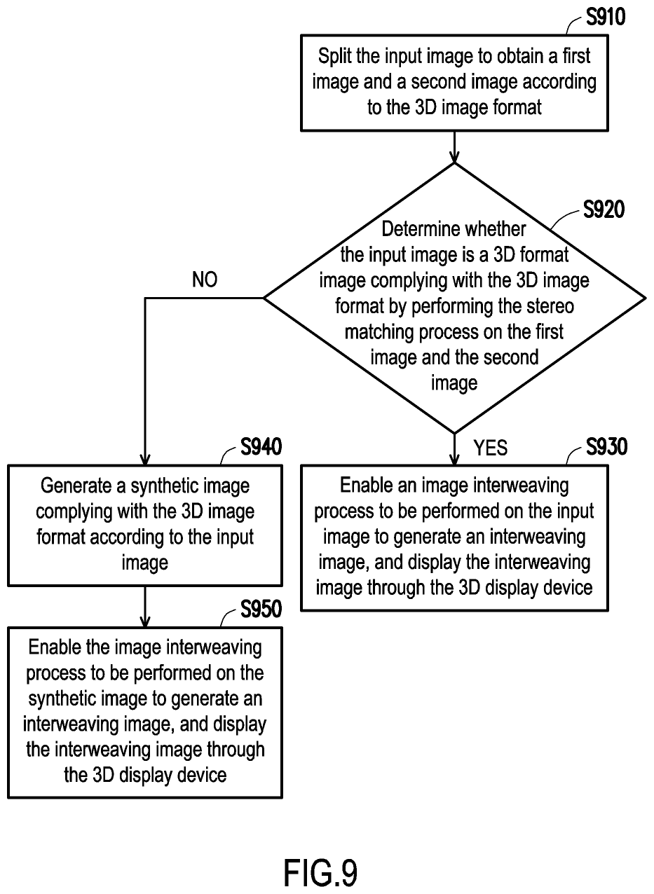

FIG. 9 is a flowchart of an image display method according to an embodiment of the disclosure. The method shown in FIG. 9 is applicable to the 3D display system 10 shown in FIG. 1. In step S910, according to the 3D image format, the processor 120 splits the input image to obtain a first image and a second image. In step S920, the processor 120 determines whether the input image is a 3D format image complying with the 3D image format by performing a stereo matching process on the first image and the second image. The detailed implementations of step S910 to step S920 have been clearly described in the relevant descriptions of FIG. 2 to FIG. 6, and will not be repeated here.

In step S930, in response to determining that the input image is a 3D format image complying with the 3D image format (the determination of step S920 is ‘yes’), the processor 120 enables an image interweaving process to be performed on the input image to generate an interweaving image, and displays the interweaving image through the 3D display device 130. The detailed implementation of step S930 has been clearly described in the relevant descriptions of FIG. 6, and will not be repeated here.

It should be noted that, in step S940, in response to determining that the input image is not a 3D format image complying with the 3D image format (the determination of step S920 is ‘no’), the processor 120 generates a synthetic image complying with the 3D image format according to the input image. In some embodiments, the processor 120 may obtain depth information according to the input image through a monocular depth estimation method, and generate an image corresponding to another viewing angle according to the above depth information. By taking the input image corresponding to another viewing angle as the left-eye image and the right-eye image respectively, the processor 120 may synthesize the input image and the image corresponding to another viewing angle to generate a synthetic image complying with the 3D image format. Next, in step S950, the processor 120 enables the image interweaving process to be performed on the synthetic image to generate an interweaving image, and displays the interweaving image through the 3D display device 130. In this way, when it is detected that the input image is not a 3D format image, the processor 120 may automatically synthesize a corresponding 3D format image for 3D display.

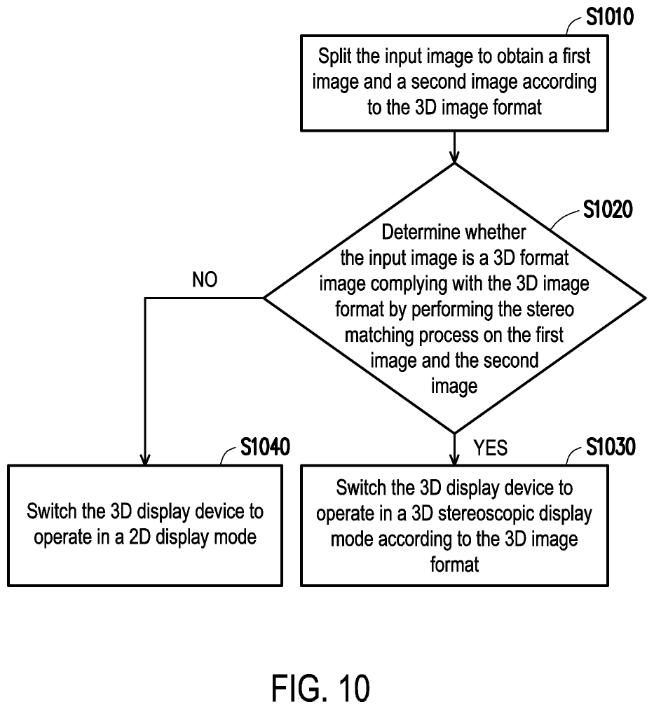

FIG. 10 is a flowchart of an image display method according to an embodiment of the disclosure. The method shown in FIG. 10 is applicable to the 3D display system 10 shown in FIG. 1. In step S1010, according to the 3D image format, the processor 120 splits the input image to obtain a first image and a second image. In step S1020, the processor 120 determines whether the input image is a 3D format image complying with the 3D image format by performing a stereo matching process on the first image and the second image. The detailed implementations of step S1010 to step S1020 have been clearly described in the relevant descriptions of FIG. 2 to FIG. 6, and will not be repeated here.

In step S1030, in response to determining that the input image is a 3D format image complying with the 3D image format (the determination of step S1020 is ‘yes’), the processor 120 switches the 3D display device 130 to operate in a 3D stereoscopic display mode according to the 3D image format. In step S1040, in response to determining that the input image is not a 3D format image complying with the 3D image format (the determination of step S1020 is ‘no’), the processor 120 switches the 3D display device 130 to operate in a 2D display mode.

Specifically, the 3D display device 130 may be switched to selectively operate in a 3D stereoscopic display mode and a 2D display mode. The processor 120 may automatically switch the display mode of the 3D display device 130 to a 3D stereoscopic display mode or a 2D display mode according to the image format of the input image. In response to the 3D display device 130 operating in the 3D stereoscopic display mode, the processor 120 may control the 3D display device 130 to display the input image or the 3D display content generated based on the input image, so the processor 120 may enable the hardware components required for 3D display or software components for related operations. For example, the interpupillary distance detection device may be enabled to detect the information of user's eye. The image interweaving process module is enabled to perform the image interweaving process on the input image. The lens element control module is enabled to control the lens element layer of the 3D display device. On the other hand, in response to the 3D display device 130 operating in the 2D display mode, the processor 120 may control the 3D display device 130 to display the input image, so the processor 120 may disable the hardware components required for 3D display or software components for related operations.

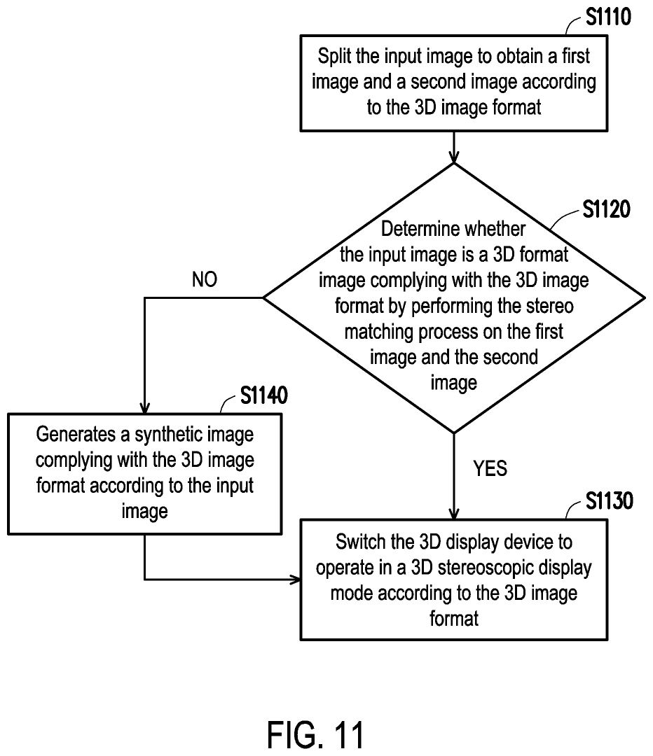

FIG. 11 is a flowchart of an image display method according to an embodiment of the disclosure. The method shown in FIG. 11 is applicable to the 3D display system 10 shown in FIG. 1. In step S1110, according to the 3D image format, the processor 120 splits the input image to obtain a first image and a second image. In step S1120, the processor 120 determines whether the input image is a 3D format image complying with the 3D image format by performing a stereo matching process on the first image and the second image. The detailed implementations of step S1110 to step S1120 have been clearly described in the relevant descriptions of FIG. 2 to FIG. 6, and will not be repeated here.

In step S1130, in response to determining that the input image is a 3D format image complying with the 3D image format (the determination of step S1120 is ‘yes’), the processor 120 switches the 3D display device 130 to operate in a 3D stereoscopic display mode according to the 3D image format. In step S1140, in response to determining that the input image is not a 3D format image complying with the 3D image format (the determination of step S1120 is ‘no’), the processor 120 generates a synthetic image complying with the 3D image format according to the input image. Then, returning to step S1130, the processor 120 switches the 3D display device 130 to operate in a 3D stereoscopic display mode according to the 3D image format. Related contents about generating a synthetic image and switching display modes have been described in the foregoing embodiments, and will not be repeated here.

It should be noted that the image display method and the processing program for detecting 3D format images executed by at least one processor are not limited to the examples of the above embodiments. For example, a part of the steps (processing) described above may be omitted, and each step may be performed in another order. In addition, any two or more of the above steps may be combined, and part of the steps may be corrected or deleted. Alternatively, other steps may also be performed in addition to the above steps.

To sum up, in the embodiment of the disclosure, it is possible to effectively identify whether the input image is a 3D format image complying with one of various 3D image formats, thereby improving the user experience and application range of the 3D display technology. For example, after determining that the input image is a 3D format image, the 3D display device may automatically switch to an appropriate display mode, and the user does not need to manually switch the display mode of the 3D display device, thereby improving the user experience. Alternatively, after determining that the input image is a 3D format image, the 3D display device may know the occupied blocks of the left-eye image and the right-eye image in the input image, so as to perform an image interweaving process required for subsequent naked-eye 3D display.

Although the disclosure has been disclosed above with the embodiments, it is not intended to limit the disclosure. Those skilled in the art may make some changes and modifications without departing from the spirit and scope of the disclosure. The scope of protection of the disclosure should be defined by the scope of the appended patent application.

What is claimed is:

1. An image display method, adapted to a 3D display system comprising a 3D display device, and the method comprising:
obtaining a first image and a second image by splitting an input image according to a 3D image format;
determining whether the input image is a 3D format image complying with the 3D image format by performing a stereo matching process on the first image and the second image; and
in response to determining that the input image is the 3D format image complying with the 3D image format, enabling an image interweaving process to perform the image interweaving process on the input image to generate an interweaving image, and displaying the interweaving image through the 3D display device.

2. The image display method of claim 1, wherein the method further comprises:
in response to determining that the input image is not the 3D format image complying with the 3D image format, disabling the image interweaving process.

3. The image display method of claim 1, wherein the method further comprises:
in response to determining that the input image is not the 3D format image complying with the 3D image format, generating a synthetic image complying with the 3D image format based on the input image, enabling the image interweaving process to be performed on the synthetic image to generate the interweaving image, and the interweaving image is displayed through the 3D display device.

4. The image display method of claim 1, wherein determining whether the input image is the 3D format image complying with the 3D image format by performing the stereo matching process on the first image and the second image comprises:
performing the stereo matching process on the first image and the second image to generate a disparity map of the first image and the second image;
calculating a matching number of a plurality of first pixels in the first image and a plurality of second pixels in the second image according to the disparity map; and
determining whether the input image is the 3D format image complying with the 3D image format according to the matching number.

5. The image display method of claim 4, wherein determining whether the input image is the 3D format image complying with the 3D image format according to the matching number comprises:
determining whether the matching number meets a matching condition;
in response to the fact that the matching number meets the matching condition, determining that the input image is the 3D format image complying with the 3D image format; and
in response to the fact that the matching number does not meet the matching condition, determining that the input image is not the 3D format image complying with the 3D image format.

6. The image display method of claim 5, wherein determining whether the matching number meets the matching condition comprises:
calculating a matching ratio of the matching number to a pixel number of the first image; and
determining whether the matching ratio is greater than a threshold value, wherein if the matching ratio is greater than the threshold value, the matching number meets the matching condition; and
if the matching ratio is not greater than the threshold value, the matching number does not meet the matching condition.

7. The image display method of claim 4, wherein the disparity map comprises a plurality of valid disparity values and a plurality of invalid disparity values, and the matching number is a number of the valid disparity values.

8. The image display method of claim 4, wherein performing the stereo matching process on the first image and the second image to generate the disparity map of the first image and the second image comprises:
taking a first image block with a first target pixel point on the first image as a center;
calculating a plurality of similarity degrees between the first image block and a plurality of second image blocks on the second image, wherein a Y-axis position of the first image block is the same as a Y-axis position of the second image block; and
obtaining a valid disparity value or an invalid disparity value corresponding to the first target pixel point on the disparity map according to the similarity degree respectively corresponding to the second image blocks.

9. The image display method of claim 8, wherein obtaining the valid disparity value or the invalid disparity value corresponding to the first target pixel point on the disparity map according to the similarity degree respectively corresponding to the second image blocks comprises:
if a second target image block matching a first target image block among the second image blocks being obtained according to the similarity degree, obtaining the valid disparity value corresponding to the first target pixel point on the disparity map based on an X-axis position of a second target pixel point centered on the second target image block and an X-axis position of the first target pixel point; and
if the second target image block matching the first target image block among the second image blocks not being obtained according to the similarity degree, obtaining the invalid disparity value corresponding to the first target pixel point on the disparity map.

10. A 3D display system, comprising:
a 3D display device;
a storage device recording a plurality of modules; and
a processor connected to the 3D display device and the storage device, and the processor configured to:
obtain a first image and a second image by splitting an input image according to a 3D image format;
determine whether the input image is a 3D format image complying with the 3D image format by performing a stereo matching process on the first image and the second image; and
in response to determining that the input image is the 3D format image complying with the 3D image format, enable an image interweaving process to perform the image interweaving process on the input image to generate an interweaving image, and display the interweaving image through the 3D display device.

11. An image display method, adapted to a 3D display system comprising a 3D display device, and the method comprising:
obtaining a first image and a second image by splitting an input image according to a 3D image format;
determining whether the input image is a 3D format image complying with the 3D image format by performing a stereo matching process on the first image and the second image; and
in response to determining that the input image is the 3D format image complying with the 3D image format, switching the 3D display device to operate in a 3D stereoscopic display mode according to the 3D image format.

12. The image display method of claim 11, wherein the method further comprises:
in response to determining that the input image is not the 3D format image complying with the 3D image format, switching the 3D display device to operate in a 2D display mode.

13. The image display method of claim 11, wherein the method further comprises:
in response to determining that the input image is not the 3D format image complying with the 3D image format, generating a synthetic image complying with the 3D image format based on the input image, and switching the 3D display device to operate in the 3D stereoscopic display mode according to the 3D image format.

14. The image display method of claim 11, wherein determining whether the input image is the 3D format image complying with the 3D image format by performing the stereo matching process on the first image and the second image comprises:
performing the stereo matching process on the first image and the second image to generate a disparity map of the first image and the second image;
calculating a matching number of a plurality of first pixels in the first image and a plurality of second pixels in the second image according to the disparity map; and
determining whether the input image is the 3D format image complying with the 3D image format according to the matching number.

15. The image display method of claim 14, wherein determining whether the input image is the 3D format image complying with the 3D image format according to the matching number comprises:
determining whether the matching number meets a matching condition;
in response to the fact that the matching number meets the matching condition, determining that the input image is the 3D format image complying with the 3D image format; and
in response to the fact that the matching number does not meet the matching condition, determining that the input image is not the 3D format image complying with the 3D image format.

16. The image display method of claim 15, wherein determining whether the matching number meets the matching condition comprises:
calculating a matching ratio of the matching number to a pixel number of the first image; and
determining whether the matching ratio is greater than a threshold value, wherein if the matching ratio is greater than the threshold value, the matching number meets the matching condition; and
if the matching ratio is not greater than the threshold value, the matching number does not meet the matching condition.

17. The image display method of claim 14, wherein the disparity map comprises a plurality of valid disparity values and a plurality of invalid disparity values, and the matching number is a number of the valid disparity values.

18. The image display method of claim 14, wherein performing the stereo matching process on the first image and the second image to generate the disparity map of the first image and the second image comprises:
taking a first image block with a first target pixel point on the first image as a center;
calculating a plurality of similarity degrees between the first image block and a plurality of second image blocks on the second image, wherein a Y-axis position of the first image block is the same as a Y-axis position of the second image block; and
obtaining a valid disparity value or an invalid disparity value corresponding to the first target pixel point on the disparity map according to the similarity degree respectively corresponding to the second image blocks.

19. The image display method of claim 18, wherein obtaining the valid disparity value or the invalid disparity value corresponding to the first target pixel point on the disparity map according to the similarity degree respectively corresponding to the second image blocks comprises:
if a second target image block matching a first target image block among the second image blocks being obtained according to the similarity degree, obtaining the valid disparity value corresponding to the first target pixel point on the disparity map based on an X-axis position of a second target pixel point centered on the second target image block and an X-axis position of the first target pixel point; and
if the second target image block matching the first target image block among the second image blocks not being obtained according to the similarity degree, obtaining the invalid disparity value corresponding to the first target pixel point on the disparity map.

20. A 3D display system, comprising:
a 3D display device;
a storage device recording a plurality of modules; and
a processor connected to the 3D display device and the storage device, and the processor configured to:
obtain a first image and a second image by splitting an input image according to a 3D image format;
determine whether the input image is a 3D format image complying with the 3D image format by performing a stereo matching process on the first image and the second image; and
in response to determining that the input image is the 3D format image complying with the 3D image format, switch the 3D display device to operate in a 3D stereoscopic display mode according to the 3D image format.
